(19) United States
(12) Patent Application Publication
(10) Pub. No.: US 2011/0127979 A1
(43) Pub. Date: Jun. 2, 2011

(54) Device for adapting source voltages

(76) Inventor: Georg Tief, Wilhelmshaven (DE)

(21) Appl. No.: 12/653,915

(22) Filed: Dec. 21, 2009

(30) Foreign Application Priority Data
Dec. 1, 2009 (DE) 20 2009 016 316.4

(51) Int. Cl. G05F 1/10

(52) U.S. Cl. 323/282

(57) ABSTRACT

The invention relates to a device for adapting the electric voltage generated by at least one electrochemical energy storage, in particular battery or accumulator, comprising at least a first electrical connection for the energy storage and comprising at least a second electrical connection for a load, which is to be supplied by the energy storage, comprising at least one transforming unit, which changes the source voltage of the energy storage and which encompasses a voltages converter and a control unit, which is in each case connected to the voltage converter. In order to creating a device for adapting a source voltage, which has an improved reliable long-term function and the production of which is relatively low-cost, at least two transforming units are connected in parallel to one another between the first and the second electrical connection. In this case, a distributor resistance is connected in series to each transforming unit.

The invention relates to a device for adapting the electric voltage generated by at least one electrochemical energy storage, in particular battery or accumulator, comprising at least a first electrical connection for the energy storage and comprising at least a second electrical connection for a load, which is to be supplied by the energy storage, comprising at least one transforming unit, which changes the source voltage of the energy storage and which encompasses a voltage converter and a control unit, which is in each case connected to the voltage converter.

Devices, such as step-up converters or step-down converters, for example, are known, by means of which a source voltage generated by one or several energy storages in battery or accumulator-operated electrical devices, among others, is increased or decreased to a load voltage, which deviates therefrom and which is required by a load. For this purpose, devices of the known species generally encompass at least a first electrical connection for the energy storage and at least a second electrical connection for the load, which is to be supplied by means of the energy storage. A transforming unit, which typically encompasses a voltage converter and a control unit, which is in each case connected to the voltage converter, is connected directly between these electrical connections. An increase or decrease, respectively, to the correspondingly required load voltage is then carried out via the voltage converter of the transforming unit as a function of the source voltage applied at the first electrical connection. The voltage converter is controlled via the control unit, which is connected thereto and which typically encompasses a measuring input for the load voltage, which is supplied directly to the load and a measuring input for a reference voltage, which is to be generated separately. In the case of the known devices, the load voltage emitted to the load is measured and is compared to the reference voltage, which can often be preset to an arbitrary value. The voltage converter, which then increases or decreases the source voltage to the load voltage which can be used by the load is then controlled via the control unit as a function of the determined difference between the load voltage and the reference voltage. It is thereby often a requirement that the source voltage of the energy storage lies clearly above or below the operating voltage of the load.

Devices of the afore-identified species are mainly used to supply power to loads, which require currents in the milliampere range or in the low, single-digit range, respectively. Attempts to actually be able to convert the power supply even in the double-digit ampere range by means of such devices resulted in the components used specifically for embodying such devices to having been realized by means of high-quality materials and extensive circuits. In spite of the high-quality components, so that the production thereof is connected to relatively high costs, the known devices encompass a relatively low operational safety due to the flowing high currents and an associated short service life.

The invention is based on the object of creating a device for adapting a source voltage, which has an improved reliable long-term function and the production of which is relatively low-cost, at the same time.

According to the invention, the object is solved by means of a device comprising the features of claim 1. Advantageous developments and embodiments of the invention are specified in claims 2 to 6.

In the case of a device for adapting the electric voltage generated by at least one electrochemical energy storage, in particular battery or accumulator, comprising at least a first electrical connection for the energy storage and comprising at least a second electrical connection for a load, which is to be supplied by the energy storage, comprising at least one transforming unit, which changes the source voltage of the energy storage and which encompasses a voltage converter and a control unit, which is in each case connected to the voltage converter, provision is made according to the invention for at least two transforming units to be connected parallel to one another between the first and the second electrical connection.

A permanent reliable voltage and power supply of the load can thus be guaranteed by means of such a device for adapting a source voltage to the required load voltage, which is embodied according to the invention. An advantageous distribution of a relatively high current, which may be required for operating the load, is carried out via the transforming units, which are connected in parallel, so that the level of the current, which flows across a transforming unit, can be limited to a certain value without any difficulty and a possible overload is thus advantageously avoided.

The number of the transforming devices, which are used, thereby depends in particular on the level of the current, which is to be maximally supplied to the load, wherein up to approximately 15 ampere can generally flow across a transforming unit. In the case of a current of maximally 50 ampere to be supplied, four such transforming units are thus required to embody the device according to the invention. The module-like embodiment of the device according to the invention furthermore has the advantage that commercially available and thus relatively low-cost components and materials can be used for the production of the transforming units. Contrary to the state of the art, the production costs can thus be kept to be relatively low in spite of increasing numbers of components.

An advantageous development of the invention provides for a distributor resistor to be connected in series to each transforming unit. In addition to an even distribution of the current load to the individual transforming units, an overload protection for the components used for embodying the different transforming units is also ensured by means of the distributor resistors. The overload protection is required specifically when the output voltage decreases drastically to an excessive degree in response to relatively high currents.

The voltage converter is preferably embodied as a step-up converter, which encompasses at least one coil, a power diode connected downstream therefrom in series and a switching element, which is connected between coil and diode and which is connected directly to the ground. In particular a voltage, which is generated by means of an electrochemical energy storage, can be increased by means of a step-up converter to an operating voltage required by the load without a relatively extensive control. Even loads, which require a relatively high power for their operation, can still be operated by means of the device according to the invention, even when the energy storage or the energy storages by themselves would no longer be able to reliably supply power to the load. The control unit connected to the voltage converter thereby automatically adapts the conversion process of the voltage converter according to the level of the source voltage, which typically decreases continuously.

It lies within the scope of the invention for each transforming unit to encompass a control element, which is connected parallel to the voltage converter, for the control unit of the transforming unit to encompass a measuring input for the source voltage, which is connected to its first electrical connection and for the control unit to be connected to the control element via a control line. In particular a direct interconnecting of the source voltage from the first electrical connection to the second electrical connection is possible via the control element, which is connected parallel to the voltage converter. The source voltage is specifically always interconnected when it is greater than the reference voltage applied at the control unit and is thus sufficient to operate the load without a direct voltage conversion. Consequently, it is now possible in connection with such a device according to the invention to also use energy storages, the source voltage of which is at least as high as the required load voltage, so that an advantageously extended service life of the load is attained. The detection of the source voltage takes place in particular via a measuring input at the control unit, which is connected via a measuring line to a power line carrying the source voltage. Via the control element, which is controlled by the control unit and which is arranged in the power line between the electrical connections, the direct power-conducting connection thereof can also be established in a relatively simple manner and can also be disconnected again.

Preferably, the control unit used in the transforming unit is a microprocessor, the use of which represents a constructively advantageous possibility for embodying a control unit. The most different control processes can then be carried out as a function of the performed programming by means of software, which is played on the microprocessor. In response to changing parameters, a relatively simple adaptation of the control unit can furthermore be carried out by means of a reprogramming. As an alternative to the microprocessor, it goes without saying that the control unit can also be embodied from common control units, such as one or several operational amplifier(s), for example, in combination with a square wave generator.

Provision is furthermore made for each control element to be a semiconductor switch, by means of which a relatively simple switching operation and, if necessary, an amplification function of electrical signals is possible. In particular a transistor or thyristor is used as semiconductor element, wherein a semiconductor switch is in each case arranged in the power line between the first and the second electrical connection and a second semiconductor switch is connected within the voltage converter between the coil thereof and the diode arranged downstream therefrom, and is simultaneously connected to ground. Both semiconductor switches are controlled via separate control lines of the control unit. Provision can furthermore be made for a capacitor to be connected so as to be electrically conductive in each case in the area of the first and of the second electrical connection. Each of the capacitors is to compensate for possible voltage fluctuations at the electrical connections, thus ensuring a direct current voltage, which is always relatively constant, at least within the transforming unit.

An exemplary embodiment of the invention, from which further inventive features result, is illustrated in the drawing.

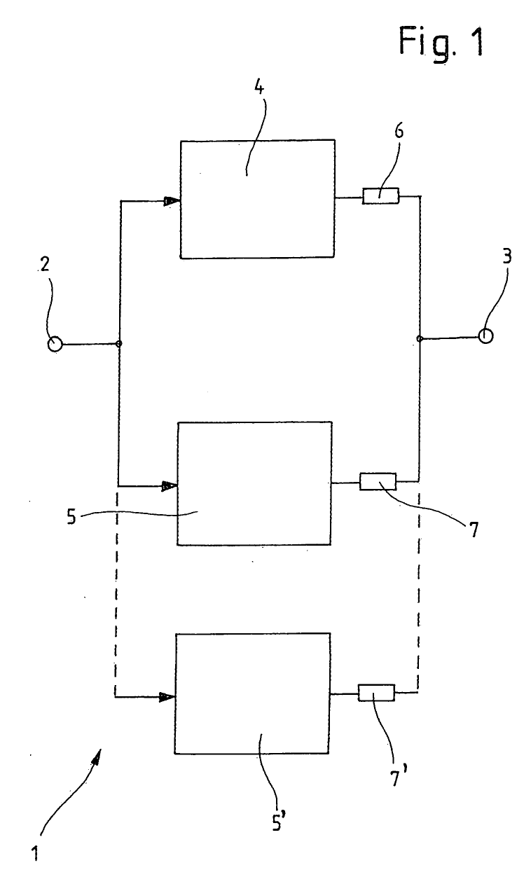

FIG. 1 shows a schematic view of the device according to the invention comprising several transforming units and

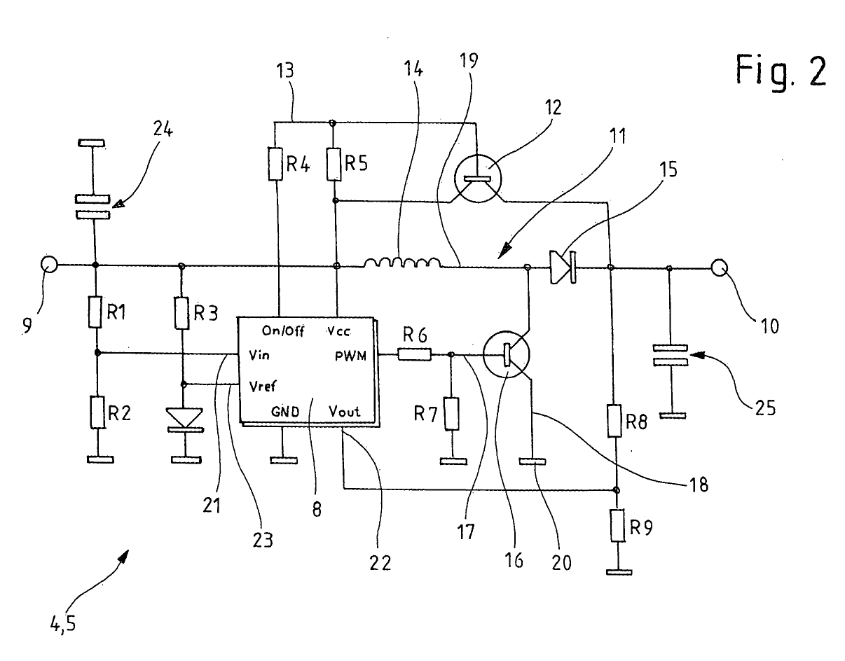

FIG. 2 shows a view of the flow diagram of the transforming unit according to FIG. 1.

FIG. 1 shows a schematic illustration of a device 1 according to the invention for adapting the source voltage supplied by at least one electrochemical energy storage to a required operating voltage of a load, which is operated by means of the energy storage. The device 1 encompasses a first electrical connection 2 for the energy storage, such as a battery or an accumulator, for example, and a second electrical connection 3 for a load, which is to be connected to the output of the device 1. The device 1 furthermore encompasses at least two transforming units 4, 5, 5′, which are connected parallel to one another between the electrical connections 2 and 3 and by means of which the source voltage applied at the electrical connection 2 is increased to the required operating voltage. A distributor resistor 6, 7, 7′ is connected in series to each transforming unit 4, 5, 5′. An even distribution of the power flowing across the transforming units 4, 5, 5′ is ensured in each case by means of said distributor resistors 6, 7, 7′. The distributor resistors 6, 7, 7′ furthermore form overload protections for the transforming units 4, 5, 5′. The number of the used transforming units 4, 5, 5′, which are always connected in parallel to one another, depends in particular on the level of the power, which is maximally expected at the electrical connection of the load, wherein two and more transforming units 4, 5, 5′ can be used without any problem.

FIG. 2 illustrates in particular the flow diagram of any transforming unit 4, 5, 5′, wherein the control unit 8, which is preferably embodied as a microprocessor, is illustrated herein as a black box. A voltage converter 11 and a control element 12 are arranged parallel to one another between the terminals 9 and 10 of a transforming unit. In the event that the control element 12 is correspondingly approached by the control unit 8 via the control line 13, the control element 12 closes and a direct power flow past the voltage converter 11 from the first electrical connection 2 to the second electrical connection (FIG. 1) is possible. In the event that the control element 12 is open, which is always the case when the source voltage falls below the required load voltage, the power flow takes place via the voltage converter 11. The voltage converter 11 encompasses a coil 14, a diode 15 connected downstream therefrom in series and a further control element 16, which is connected between coil 14 and diode 15 and which is directly connected to the ground. At the same time, the control element 16 is opened and closed in predetermined intervals by means of the control unit 8 via the control line 17 by means of a power signal, which is generated by the control unit 8 and which increases and decreases again in continuous sequence. A connection between the conductor 19 and the ground 20 is thus created via the power line 18. This continuously running switching operation changes the inductivity of the coil 14 and thus the source voltage, wherein the source voltage is interconnected from the diode 15 to the second terminal 10 in the event that the source voltage exceeds a certain value. The control unit 8 furthermore encompasses a measuring input 21 for the source voltage supplied by the energy storage, a measuring input 22 for the supplied load voltage and a measuring input 23 for the preadjustable reference voltage. The capacitors 24, 25, which are connected in the area of the terminals 9, 10, in particular serve the purpose of compensating for occurring voltage fluctuations, so as to avoid excessive voltages as well as to intercept low voltages. The electric voltage of the device 1 according to the invention furthermore encompasses a plurality of resistors R1 to R9, which in particular serve the purpose of adapting and adjusting measuring and control signals.

1. A device for adapting the electric voltage generated by at least one electrochemical energy storage, in particular battery or accumulator, comprising at least a first electrical connection for the energy storage and comprising at least a second electrical connection for a load, which is to be supplied by the energy storage, comprising at least one transforming unit, which changes the source voltage of the energy storage and which encompasses a voltage converter and a control unit, which is in each case connected to the voltage converter,
that wherein at least two transforming units (4, 5, 5′) are connected in parallel to one another between the first and second electrical connection (2, 3).

2. The device according to claim 1, wherein a distributor resistance (6, 7, 7′) is connected in series to each transforming unit (4, 5, 5′).

3. The device according to claim 1, wherein the voltage converter (11) is embodied as a step-up converter.

4. The device according to claim 1, wherein each transforming unit (4, 5, 5′) encompasses a control element (12) connected parallel to the voltage converter (11), wherein the control unit (8) of the transforming unit (4, 5, 5′) encompasses a measuring input for the source voltage applied at the terminal (9) and wherein the control unit (8) is connected to the control element (12) via a control line (13).

5. The device according to claim 1, wherein the control unit (8) is a microprocessor.

6. The device according to claim 4, wherein each control element (12, 16) is a semiconductor switch.
